(19) United States
(12) Patent Application Publication
(10) Pub. No.: US 2018/0277985 A1
(43) Pub. Date: Sep. 27, 2018

(54) CIRCUIT BOARD CONNECTOR

(71) Applicant: Dongguan Leader Precision Industry Co., Ltd., Dongguan City (CN)

(72) Inventor: SHANGJU TSAI, Dongguan City (CN)

(21) Appl. No.: 15/928,108

(22) Filed: Mar. 22, 2018

(30) Foreign Application Priority Data
Mar. 24, 2017 (CN) 201710181847.8

(51) Int. Cl. H01R 13/52; H01R 12/51; H01R 13/502; H01R 13/41

(52) U.S. Cl. CPC H01R 13/5216; H01R 13/41; H01R 13/502; H01R 12/51

(57) ABSTRACT

The present invention discloses a circuit board connector comprising an insulating body, conductive terminals set in the insulating body and a metal shell enclosing the insulating body. Said insulating body includes at least one cavity, the connecting portion of at least some conductive terminals being exposed to the cavity. The cavity has a surface exposed to the outside and the cavity is filled with the nonconductor filler having a sealing action.

### BACKGROUND OF THE INVENTION

### 1. Field of the Invention

The present invention relates to a circuit board connector, and particularly to a circuit board connector having a waterproof function.

### 2. Description of Related Art

Because the C-type USB connector has a positive and negative plug function and high frequency transmission rate, it is more and more widely used in electronic products, especially welded on a circuit board inside of the electronic product and considered as being a circuit board connector. The C-type USB connector generally includes an insulating body, an upper and a lower row of conductive terminals set in the insulating body and a metal shell enclosing the insulating body. The metal shell is provided with a receiving space for receiving a docking connector. The insulating body includes a tongue plate located in the receiving space and the conductive terminals are arranged on the upper and lower surfaces of the tongue plate for being contact with the docking connector.

Taking into account the difference of the operating environment of the electronic products, in order to ensure that electronic products can work effectively and steadily in a special environment. Some requirements, such as waterproof, dustproof are requested for the electronic products. Most of the existing circuit board connectors are made by fixing the conductive terminals to the insulating body by insert molding. The metal shell is a seamless structure. Finally, a glue-enveloping disposal is made at the joint between the metal shell and the insulating body to fill the gap therebetween or a seal ring is used for waterproof, such as the waterproof structure disclosed in the Chinese patent ZL201520176289.2 or WO2011/115788.

Because normally the conductive terminals of the electrical connector are integrally formed in the insulating body by an insert molding process, the seal between the conductive terminals and the insulating body is good. However, the weld process of the circuit board of the electrical connector is cooled from the high temperature to the room temperature, so a small gap is generated because of the difference of the Coefficient of Thermal expansion between the conductive terminals and the insulating body and a decrease in water resistance is generated. With the growth of time or at a high temperature and humidity conditions, moisture or water vapor can go into the electronic products through the gap via the conductive terminals exposed to the surface of the tongue plate, resulting in damage to electronic products.

### BRIEF SUMMARY OF THE INVENTION

In order to overcome the shortcomings of the prior art, the present invention provides a circuit board connector which improves the waterproof and airtightness.

The technical solution for solving the technical problem of the invention is:

A circuit board connector comprising an insulating body, conductive terminals set in the insulating body and a metal shell enclosing the insulating body. The metal shell is provided with a receiving space. The insulating body includes a body portion and a tongue plate extending from the body portion to the receiving space. The conductive terminal includes a contact portion arranged on the surface of the tongue plate and the contact portion can electrically connect to a docking connector. The conductive terminal includes a welding portion extending outside of the insulating body and the welding portion can be welded to a circuit board. The conductive terminal includes a connecting portion which connects the contact portion with the welding portion. The insulating body includes at least one cavity, the connecting portion of at least some conductive terminals being exposed to the cavity. The cavity includes a surface exposed to the outside and the cavity is filled with a non-conductor filler that acts as a seal.

As an improvement of the above-described technical solution, the filler is a colloid having a different thermal expansion coefficient with the insulating body and the conductive terminals.

As a further improvement of the above-described technical solution, the filler is a polymer material having a different chemical composition with the insulating body.

Further, the cavity is located in the body portion.

Further, the insulating body is formed by at least two insulators.

Further, the filler is partially fixed to an insulator.

Further, the two insulators have a partition wall.

Further, the partition wall is a metallic material.

Further, the partition wall is an integral part of the insulating body.

Further, the welding portion extends outside of the body portion and is bent in a flat shape.

The advantage of the invention is that: the insulating body includes at least one cavity. The connecting portion of at least some conductive terminals are exposed in the cavity and the cavity has a surface exposed to the outside. A non-conductor filler is disposed in the cavity for a sealing effect, thereby enhancing the waterproof and airtightness function. The filler is a colloid having a different thermal expansion coefficient from the insulating body and the conductive terminal. And further, the filler is a polymer material different from the insulating body. The filler can be firmly adhered to the conductive terminals. Even if it is deteriorated under high temperature and humidity conditions or after long-term use, a gap can't be generated between the conductive terminals held in the insulating body and the filler so that moisture or water air is prevented from penetrating into the insulating body from the conductive terminal contact portion exposed to the surface of the tongue plate and then entering the welding portion through the gap in the insulating body, causing damage to the electronic product and the waterproof level having a large raise. In the past, the waterproof is simply gained via put a seal ring outside the connector. And further a waterproof is gained from the inside of the connector to achieve a more sophisticated waterproof effect. In addition, by setting filler in the cavity, a better shape of the filler and fixed role, the filler does not easily overflow to the connector surface, and therefore, the appearance of the connector can't be influenced.

### BRIEF DESCRIPTION OF THE DRAWINGS

The invention will now be further described with reference to the accompanying drawings and embodiments.

FIG. 1 is a schematic view in an assembled state of the present invention;

FIG. 2 is a schematic view in the exploded state of the present invention;

FIG. 3 is a schematic view showing the insulating body in the present invention;

FIG. 4 is a schematic cross-sectional view of the insulating body along the line A-A in FIG. 3;

FIG. 5 is a schematic cross-sectional view of the insulating body along the line B-B in FIG. 3;

FIG. 6 is a schematic view showing the cavity filled with filler;

FIG. 7 is a schematic view showing a partition wall in the cavity;

FIG. 8 is a schematic view showing the cavity filled with filler in FIG. 7;

FIG. 9 is a schematic view showing two insulators in the present invention.

### DETAILED DESCRIPTION OF THE PREFERRED EMBODIMENT

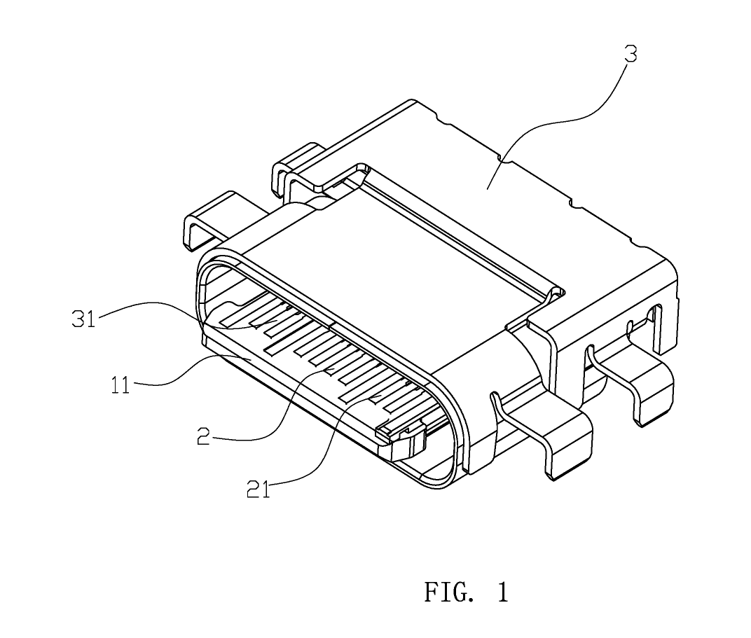

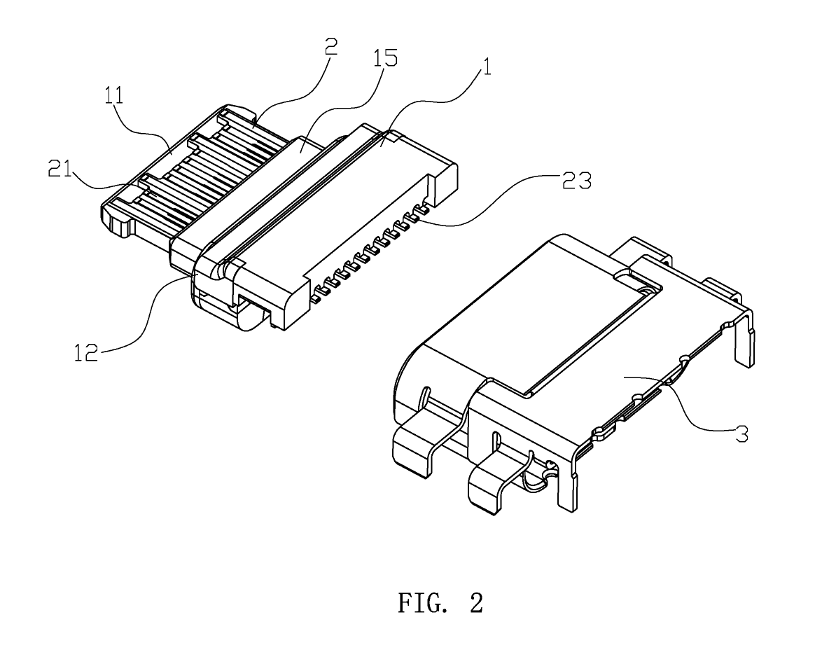

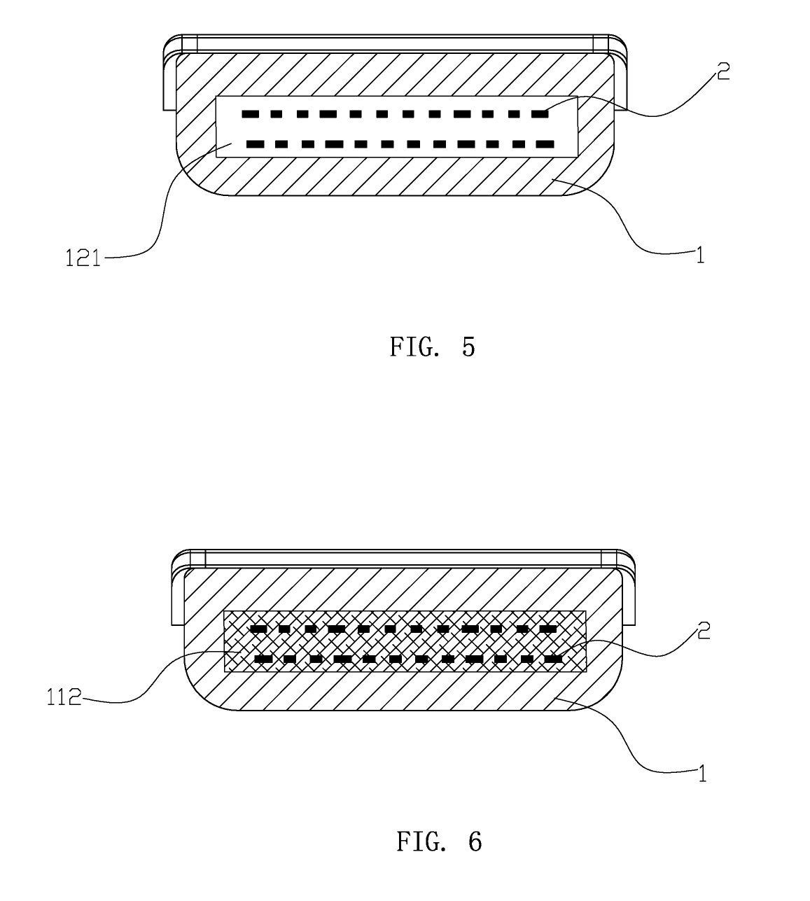

Refer to FIGS. 1 to 6, a preferred embodiment disclosed in the present invention is a type-C USB connector. Anyone skilled in the art knows that the technique of the present invention cannot limit to the C-type USB connector. The technical application of the invention is subject to the scope of the claims as defined in the claims. The connector comprises an insulating body 1, conductive terminals 2 set in the insulating body 1 and a metal shell 3 enclosing the insulating body 1. The metal shell 3 is provided with a receiving space 31. The insulating body 1 comprises a body portion 12 and a tongue plate 11 extending from the body portion 12 to the receiving space 31. The conductive terminal 2 includes a contact portion 21 arranged on the surface of the tongue plate 11, and the contact portion 21 of each of the conductive terminals 2 can be electrically connected to a docking connector. Each of the conductive terminals 2 extends outside the insulating body 1 to form a welding portion 23. Each of the welding portion 23 is welded to a circuit board, and each of the conductive terminals 2 has a connecting portion 22. The connecting portion 22 connects the contact portion 21 with the welding portion 23, respectively. The insulating body 1 is provided with at least one cavity 121.

Refer to FIG. 4, in the present embodiment a main portion 15 is set between the body portion 12 of the insulating body 1 and the tongue plate 11 so that the cross section from the body portion 12 to the tongue plate 11 is step shaped, i.e. the body portion 12 has a maximum side profile size, the side profile size of the main portion 15 is smaller than the body portion 12, and the tongue plate 11 has a minimum side profile size. The cavity 121 is located between the body portion 12 and the main portion 15 and the connecting portion 22 of at least some conductive terminals 2 is exposed in the cavity 121. The cavity 121 has a surface exposed to the outside. The cavity 121 is filled with a non-conductor filler 112 having a sealing function. By exposing the surface of the cavity 121 to the outside, it is ensured that the filler 112 can be filled into the cavity 121.

Refer to FIG. 4, the cavity 121 is located between the body portion 12 and the main portion 15, which is merely an option to carry out the invention. One skilled in the art can move the cavity 121 in the insulating body 1, for example, completely moving the cavity 121 to the body portion 12, or moving the cavity 121 between the main portion 15 and the tongue plate 11 of the insulating body 1. The cavity 121 can be completely moved into the range of the tongue plate 11.

The filler 112 in the cavity 121 of the insulating body 1 is a colloid having a different thermal expansion coefficient from the insulating body 1 and the conductive terminals 2. Furthermore, the filler 112 is a polymer material having a different chemical composition from the insulating body 1. Inside of the cavity 121, because some conductive terminals 2 are exposed to the cavity 121, when the cavity 121 is filled with an appropriate filler 112, the filler 112 simultaneously contacts with the conductive terminals 2 and the insulating body 1. Since the filler 112 simultaneously contacts with the majority of the conductive terminals 2, the filler 112 can't be a conductive material.

The filler 112 can't be a nylon (Nylon) or polyvinyl chloride (PVC) having a higher thermal expansion coefficient because the filler 112 may be partially liquefied even at high temperatures occurred in the welding process of the connector and may fill the gap between the conductive terminals 2 and the insulating body 1. When cooled to the room temperature, the volume of the high thermal expansion material shrinks relatively large and it is possible to restore the gap between the conductive terminals 2 and the insulating body 1. In order to allow the filler 112 to fill the gap between the conductive terminals 2 and the insulating body 1, the filler 112 may be clay, ceramic and/or silicon-containing material having a small thermal expansion coefficient. The suitable low thermal expansion coefficient materials of the present invention are not limited to the foregoing examples, and if a specific polymer material such as rubber, silicone adhesive, elastomeric polymer, co-polyimides or a thermoplastic polymer etc., has a low coefficient of thermal expansion and can still be used as the filler 112 in the present invention, which should be described.

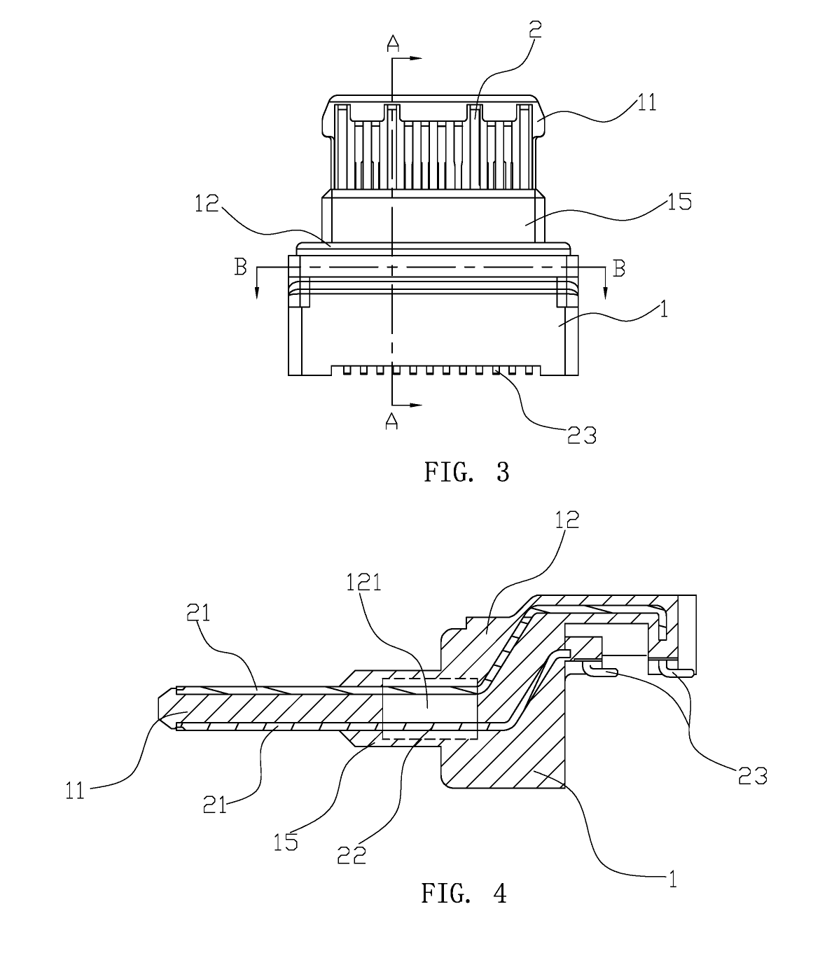

Refer to FIGS. 3 and 4, the cavity 121 is not exposed to the outside because there are too many possibilities of implementation that the cavity 121 is exposed to the outside. For avoiding the technique of the invention is misinterpreted as being limited to one or some of the means, the main purpose of exposing the cavity 121 to the outside is to allow the filler 112 to be filled within the cavity 121, so that exposing the cavity 121 to the outside is not limited to any particular technical mean.

The filler 112 having a small thermal expansion coefficient can be stably filled in the cavity 121 with the connector cooled to room temperature from the high temperature of the in the entire process of welding, thereby preventing air water or liquid water from passing through the gap between the conductive terminals 2 and the insulating body 1.

In this embodiment, the filler 112 is filled in the cavity 121, which may be partially filled in the cavity 121 so that the filler 112 is attached to the gap between the conductive terminal 2 and the insulating body 1 by the means of smeared, stained or covered, etc. As a result, since the filler 112 is firmly adhered to the conductive terminals 2 and the insulating body 1, no gap can be generated even after severe conditions such as high temperature and humidity or long term use.

Refer to FIG. 4, the welding portion 23 extends outside of the body portion 12 and then is bent flat so as to be quickly welded to the external circuit board by a surface mount (SMT) process. It is this preferred embodiment that assumes that the electrical connector is welded to the circuit board using a surface mount process and that the technology disclosed by the present invention can be applicable to conventional electrical connectors that are welded through the through holes. Since the surface mount process is subject to the curing of the solder paste at a high temperature, the high temperature causes the insulating body 1 and the conductive terminal 2 to expand due to the thermal expansion and contraction properties of the material, and the gap between the conductive terminals 2 and the insulating body 1 is likely to be generated after cooling. The filler 112 located in the cavity 121 has a different coefficient of thermal expansion from the insulating body 1 and the conductive terminal 2 so as to be closely adhered to the surface of the connecting portion 22 of the conductive terminals 2 and to fill the space between the connecting portions 22 of the conductive terminals 2 and the insulating body 1, so as to prevent the gap generated between the two-material interface. Thereby preventing air water or liquid water from penetrating into the insulating body 1 from the contact portion 21 exposed to the surface of the tongue 11 and passing through the gap in the insulating body 1 into the welding portion 23 to cause damage to the electronic product and a waterproof lever is greatly improved. In the past, simply the seal is disposed outside the connector for waterproof, and further now in the present invention, the waterproof performance is improved from the internal structure of the connector, so that a more sophisticated waterproof effect is achieved.

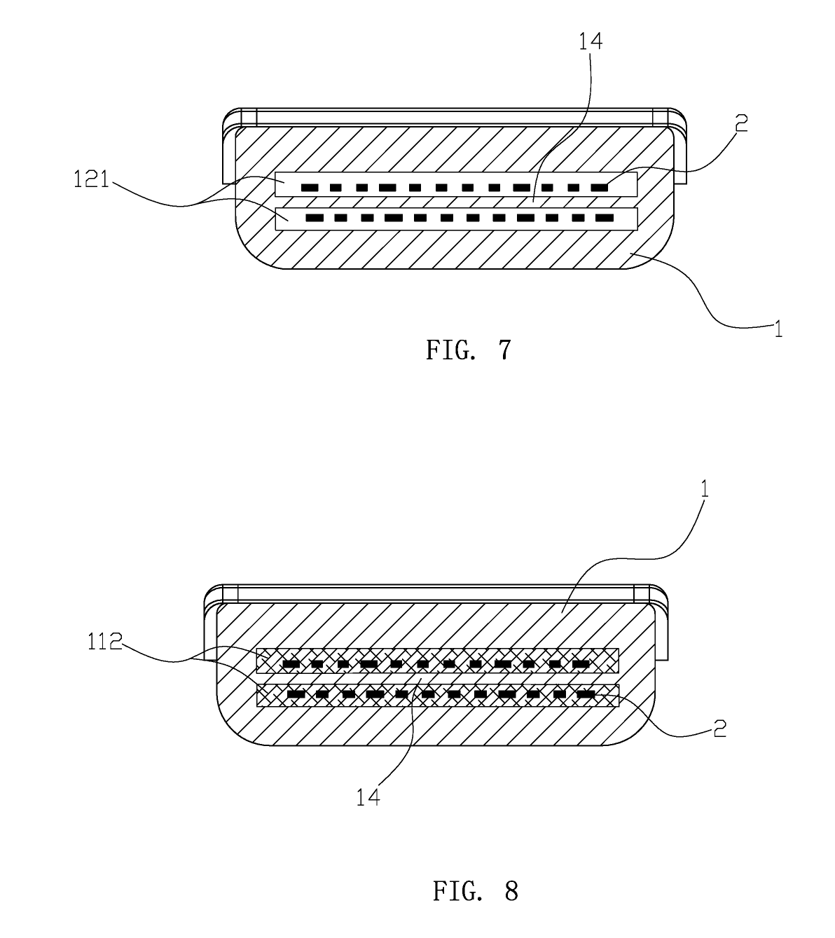

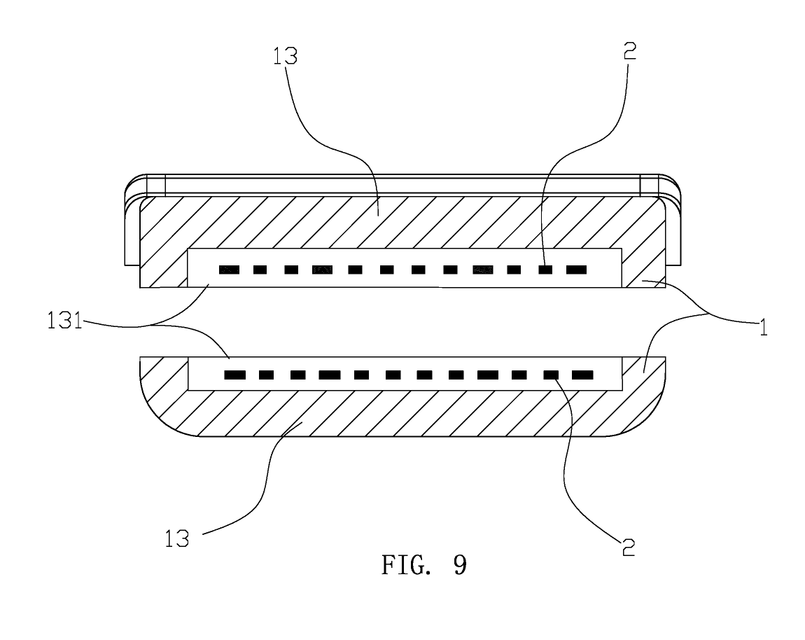

Refer to FIGS. 7 to 9, the insulating body 1 is formed by at least two insulators 13, and the conductive terminals 2 are arranged in two rows, i.e., each insulator 13 fixes a number of conductive terminals 2. The filler 112 is partially fixed to an insulator 13. Two insulators divide the cavity 121 into two portions having openings 131, respectively, so that the filler 112 can be filled into the insulators 13 through the opening 131. In the present embodiment, the opening 131 constitutes a surface in which the cavity 121 is exposed to the outside. The two insulators 13 have a partition wall 14 which is a metallic material, or the partition wall 14 is integrally formed by the insulating body 1.

In the present invention, at least one cavity 121 is provided in the insulating body 1, and the connecting portions 22 of at least some conductive terminal 2 are exposed in the cavity 121. The cavity includes a surface exposed to the outer of the insulating body 1. The cavity 121 is filled with a non-conductor filler 112 having a sealing action, thereby enhancing the waterproof and airtightness.

In addition, the filling of the filler 112 by the provision of the cavity 121 serves to provide a better fixation of the filler 112. The filler 112 does not easily overflow onto the connector surface and therefore does not affect the appearance of the connector.

The foregoing is intended to be a preferred embodiment of the present invention, but the present invention is not limited to the above-described embodiments and should fall within the scope of the present invention as long as it achieves the technical effects of the present invention by any of the same or similar means.

What is claimed is:

1. A circuit board connector comprising an insulating body, conductive terminals set in the insulating body and a metal shell enclosing the insulating body, the metal shell including a receiving space, the insulating body including a body portion and a tongue plate extending forward from the body portion into the receiving space, the conductive terminal including a contact portion arranged on the surface of the tongue plate, the contact portion of each conductive terminal being electrically connected to a docking connector, each of the conductive terminals extending outside of the insulating body to form a welding portion, the welding portion being welded to a circuit board, each conductive terminal including a connecting portion which connects the contact portion and the welding portion, respectively, wherein said insulating body includes at least one cavity, the connecting portion of at least some conductive terminals being exposed to the cavity, the cavity being filled with the nonconductor filler having a sealing action.

2. The circuit board connector according to claim 1, wherein the cavity having a surface exposed to outside of the insulating body.

3. The circuit board connector according to claim 1, wherein the insulating body includes two insulators, the two insulators divide the cavity into two portions having openings respectively, the opening constitutes a surface in which the cavity is exposed to the outside, the surface is disposed in a mating position of the two insulators, the conductive terminals are arranged in two rows retained on the two insulators.

4. The circuit board connector according to claim 1, wherein the filler is a colloid having a different thermal expansion coefficient from the insulating body and the conductive terminal.

5. The circuit board connector according to claim 1, wherein the filler is a polymer material having a different chemical composition from the insulating body.

6. The circuit board connector according to claim 1, wherein the cavity is located in the main body.

7. The circuit board connector according to claim 3, wherein said two insulators include a partition wall therebetween.

8. The circuit board connector according to claim 7, wherein said partition wall is a metallic material.

9. The circuit board connector according to claim 7, wherein the partition wall is an integral part of the insulating body.

10. The circuit board connector according to claim 1, wherein the welding portion extends outside of the body portion and is bent in a flat shape.

11. A circuit board connector comprising:
an insulating body including a body portion and a tongue plate extending forward from the body portion;
at least one conductive terminal set in the insulating body, the conductive terminal including a contact portion arranged on the surface of the tongue plate, a welding portion extending outside of the insulating body and a connecting portion connecting the contact portion and the welding portion; and
a metal shell enclosing the insulating body, wherein said insulating body includes at least one cavity which is filled with a nonconductor filler, the connecting portion being disposed in the cavity and integrated with the nonconductor filler.

12. The circuit board connector according to claim 11, wherein the cavity including an opening connecting to the outside.

13. The circuit board connector according to claim 11, wherein the filler is a colloid having a different thermal expansion coefficient from the insulating body and the conductive terminal.

14. The circuit board connector according to claim 11, wherein the filler is a polymer material having a different chemical composition from the insulating body.

15. The circuit board connector according to claim 11, wherein the insulating body is formed by at least two insulators.

16. A circuit board connector comprising:
an insulating body including at least two insulators;
conductive terminals set in the insulators, each conductive terminal including a contact portion, a welding portion extending outside of the insulating body and a connecting portion connecting the contact portion and the welding portion; and
a metal shell enclosing the insulating body, wherein said each insulator includes at least one cavity which is filled with a nonconductor filler, the connecting portion being disposed in the cavity and fixed by the nonconductor filler.

17. The circuit board connector according to claim 16, wherein the filler is a colloid having a different thermal expansion coefficient from the insulating body and the conductive terminal.

18. The circuit board connector according to claim 16, wherein the filler is a polymer material having a different chemical composition from the insulating body.

19. The circuit board connector according to claim 16, wherein the cavity including an opening connecting to the outside.

20. The circuit board connector according to claim 16, wherein said two insulators include a partition wall therebetween.
